(19) United States
(12) Patent Application Publication
(10) Pub. No.: US 2008/0010146 A1
(43) Pub. Date: Jan. 10, 2008

(54) Marketing tool

(75) Inventors: Brian J. Gillespie, Denver, CO (US); Patricia A. Kennedy, Denver, CO (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Proctor & Gamble Company

(21) Appl. No.: 11/483,508

(22) Filed: Jul. 10, 2006

(51) Int. Cl. G06Q 30/00

(52) U.S. Cl. 705/14

(57) ABSTRACT

A marketing tool for marketing a product and informing a consumer of at least one product feature is provided. The marketing tool includes a feature representation aspect that demonstrates a feature of the product to a consumer through the use of a material that is representative of the feature of the product.

### FIELD OF THE INVENTION

This invention relates generally to marketing tools, and more specifically to marketing tools including a feature representation aspect.

### BACKGROUND OF THE INVENTION

A broad range of consumer products are sold, including, for example, absorbent articles, cleaning products, batteries, beauty care products, medical products, medical devices, food products, and many other products. Absorbent articles may include, for example, bath tissue, paper towels, wipes (e.g., disinfectant, cleansing, facial, hand, baby, perineal), diapers, training pants, catamenial products, wound care dressings, incontinence pads, and bandages. Cleaning products may include absorbent articles and may further include laundry products such as fabric softener sheets and dish care products such as cleaning foam. Beauty care products may include, for example, antiperspirants, razors, toothpaste, skin care products such as lotion, cosmetics such as pressed powders, and hair care products such as hairspray. Medical products and medical devices may include medications, pharmaceuticals, bandages such as athletic bandages or wound care bandages, syrups, and salves. Food products may include, for example, snacks such as chips, and coffee, tea, and other beverages.

Product marketing of consumer products of all types can be challenging insofar as features of the product that may be of importance to a consumer may not be conveyed using standard marketing materials, and may not be available to the consumer via standard product packaging. For example, physical, olfactory, or visual features may be important to a consumer purchasing a product, but may not be conveyed in standard graphic-based or text-based marketing materials, or by standard product packaging. If such features were communicated to a consumer, the consumer could make a more-informed purchasing decision. Thus, a need exists for a marketing tool including a feature representation of a product.

### SUMMARY OF THE INVENTION

Marketing tools, and, more specifically, marketing tools including a feature representation aspect, are provided. The marketing tools herewith provided communicate one or more features, such as texture, thickness, softness, smoothness, durability, or scent, of the product to a consumer. By demonstrating a feature of the product to the consumer, the marketing tool better meets the needs of the consumers and enables consumers to make a more informed purchasing decision.

In one embodiment, the marketing tool comprises a feature representation aspect that demonstrates a physical feature of the product to a consumer. The physical feature of the product is demonstrated to the consumer through the use of a material that is representative of the physical feature.

In another embodiment, the marketing tool is configured for marketing a disposable article. The marketing tool comprises a base aspect and a texture representation aspect. The texture representation aspect substantially demonstrates the texture of the disposable article to a consumer.

In a further embodiment, the marketing tool comprises a display having a front surface and a back surface. An affixation mechanism is provided on the back surface of the display and a textured material provided on the front surface of the display. The textured material demonstrates a texture of the product.

In yet another embodiment, the marketing tool comprises a display configured for coupling to a surface. The display has a feature representation portion that demonstrates a physical feature of the product. The feature representation portion is provided on a front surface of the display.

In a further embodiment, the marketing tool comprises a product packaging and a feature representation portion. The feature representation portion is provided as part of the product packaging and simulates a feature of the product.

While multiple embodiments are disclosed herein, still other embodiments of the invention will become apparent to those skilled in the art from the following detailed description, which shows and describes illustrative embodiments of the invention. As will be realized, the invention is capable of modifications in various obvious aspects, all without departing from the spirit and scope of the invention. Accordingly, the drawings and detailed description are to be regarded as illustrative in nature and not restrictive.

### BRIEF DESCRIPTION OF THE DRAWINGS

FIG. 1a illustrates a marketing tool for use with a shopping cart handle in accordance with one embodiment of the present invention.

FIG. 1b illustrates a marketing tool for use with a shopping cart handle in accordance with another embodiment of the present invention.

FIG. 1c illustrates a marketing tool for use with a shopping cart handle in accordance with another embodiment of the present invention.

FIG. 1d illustrates a marketing tool for use with a shopping cart seat in accordance with another embodiment of the present invention.

FIG. 2 illustrates a marketing tool for distribution to consumers in accordance with one embodiment of the present invention.

FIG. 3 illustrates a marketing tool for display in a store aisle in accordance with one embodiment of the present invention.

FIG. 4 illustrates a marketing tool for display on a surface in accordance with one embodiment of the present invention.

FIG. 5 illustrates a marketing tool integral with product packaging in accordance with one embodiment of the present invention.

### DETAILED DESCRIPTION OF THE INVENTION

Marketing tools, and, more specifically, marketing tools including a feature representation aspect, are provided. The marketing tools may be used to market any suitable product such as an absorbent article, a cleaning product, a beauty care product, a medical product, a medical device, a food product, or other products. Further, the product marketed may be a disposable article, such as, for example, a roll of paper towels or bath tissue.

A broad range of product features, such as physical, olfactory, or visual features, may be important to consumers when deciding whether to purchase a particular product. Physical features may include, for example, texture, thickness, softness, smoothness, and/or durability. One or more of these and other features may be communicated to a consumer using the marketing tools provided. Generally, thus, the marketing tools of the present invention comprise a product feature aspect for demonstrating a feature of the product to a consumer.

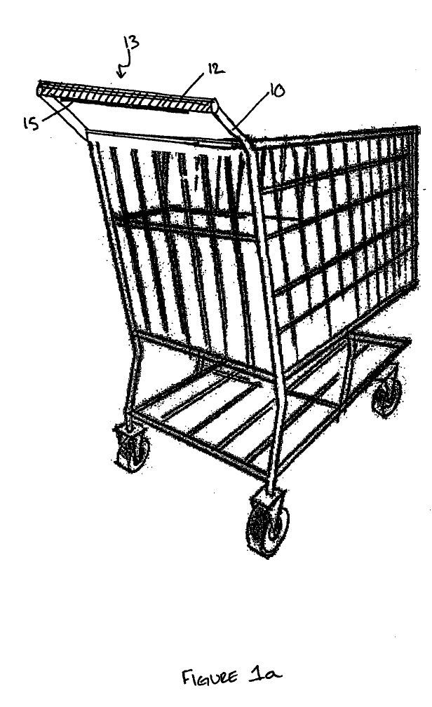

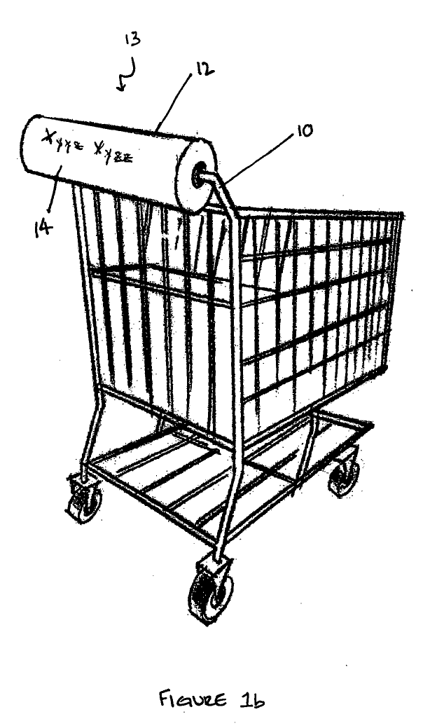

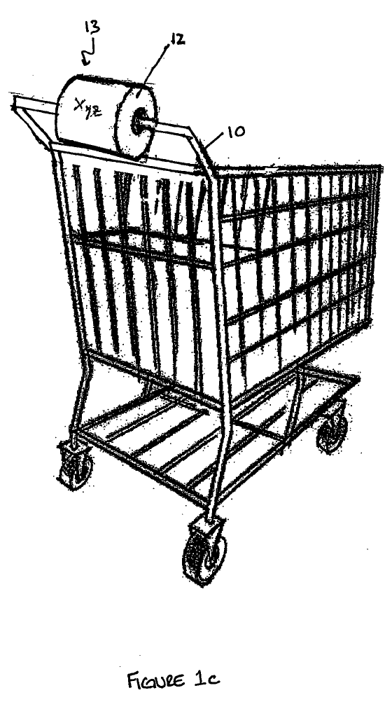

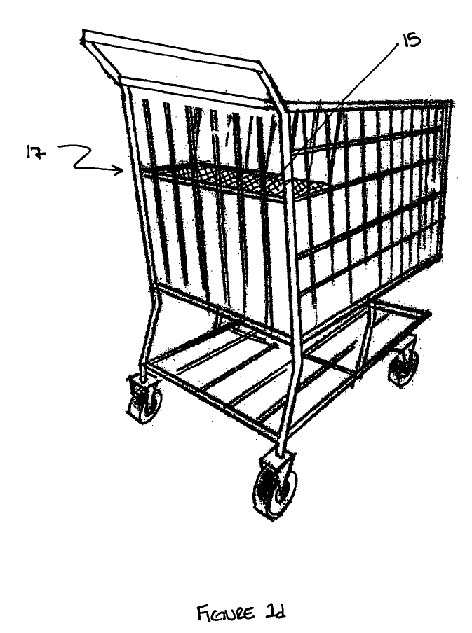

FIG. 1a illustrates one embodiment of a marketing tool 13 including a feature representation aspect, such as for a roll of paper towels. As shown in FIG. 1a, the marketing tool 13 comprises a surface 12. The surface 12 includes a feature representation aspect and may be any portion of a handle, or a complete handle, for affixation to a shopping cart, or it may be a cover for placement over an existing shopping cart handle. The marketing tool 13 may be attached to the shopping cart handle 10 by any suitable means. As shown, the marketing tool 13 is sized to roughly correspond to the size of a standard shopping cart handle 10. Further, the marketing tool 13 may be designed to fit over a standard shopping cart handle 10. Thus, the marketing tool 13 may be provided with an opening 15 for receipt of the shopping cart handle 10. Alternatively, the marketing tool 13 may be configured to replace and function as a conventional shopping cart handle 10, or a portion thereof.

In the embodiment shown, the surface 12 of the marketing tool 13 is a textured surface. The surface 12 is configured to demonstrate the texture of the product being advertised. The embodiments disclosed herein may demonstrate a physical feature such as texture, thickness, softness, smoothness, and/or durability, and/or may demonstrate another product feature, though the use of an actual sample of the product, or through the use of a material that is representative of certain features of the product. The surface 12 may be any desired degree of softness or firmness. Further, the marketing tool may be configured to simulate more than one product feature. Thus, for example, the marketing tool may simulate texture and scent of the product, texture and durability of the product, texture and visual appearance of the product, visual appearance and scent of the product, or any other combination of product features.

The surface 12 shown in FIG. 1a may be demonstrated to the consumer through the use of an actual product sample, a representation of the product, or in any other suitable manner. If a product sample is used, the product sample may be covered with a protective material, such as a generally transparent material, or a material that can be molded or formed to permit the consumer to experience the particular product feature or features being demonstrated. The product sample also may be replaceable, in case it becomes soiled, worn, damaged, or depleted.

Other features of the product also may be demonstrated to the consumer by providing features on the surface 12 that represent the desired feature of the product. The surface 12 may be manufactured of any suitable material for demonstrating the desired feature. The surface 12 may be plastic, metal, foam, rubber, hard material etched with a pattern, or any other suitable material or combination of materials.

As shown in FIG. 1b, the marketing tool 13 may further include advertising indicia 14, such as graphics or text identifying and advertising the product.

The shopping cart handle 10 and marketing tool 13 may comprise different diameters. FIG. 1c illustrates an embodiment of the present invention in which the marketing tool 13 is generally positioned near the center of the shopping cart handle 10. The marketing tool 13 is sized to approximate a roll of bath tissue. The surface 12 of FIG. 1c demonstrates one or more features of the bath tissue, such as its texture.

As illustrated in FIGS. 1b and 1c, the marketing tool 13 may be configured to be any desired size. For example, as in the embodiment of FIG. 1b, a marketing tool 13 that represents paper towels may be generally the diameter of a roll of paper towels. As shown in FIG. 1a, the marketing tool 13 may be the diameter of normal shopping cart handles. Alternately, the marketing tool 13 may be any other desired diameter.

FIG. 1d illustrates an alternate embodiment of a marketing tool including a feature representation aspect. As shown in FIG. 1c, the marketing tool comprises a shopping cart child seat 17 having a surface 15 that demonstrates a feature, such as the texture, of the product being advertised. The shopping cart child seat 17 may be a toddler seat, as is commonly provided in a shopping cart, or an infant seat. A surface of the shopping cart child seat 17 comprises the surface 15. Thus, when the surface 15 is configured for representing the texture of the product, the shopping cart child seat 17 may be formed of a material that demonstrates the texture of the product. Alternately, a layer of material representing the texture of the product may be provided over the shopping cart child seat 17. The surface 15 may be manufactured of any suitable material for simulating the desired product feature. The surface 15 may be the actual product, or it may be plastic, metal, foam, rubber, hard material etched with a pattern, or other suitable material. The shopping cart child seat 17 may further include advertising indicia such as graphics or text identifying and advertising the product.

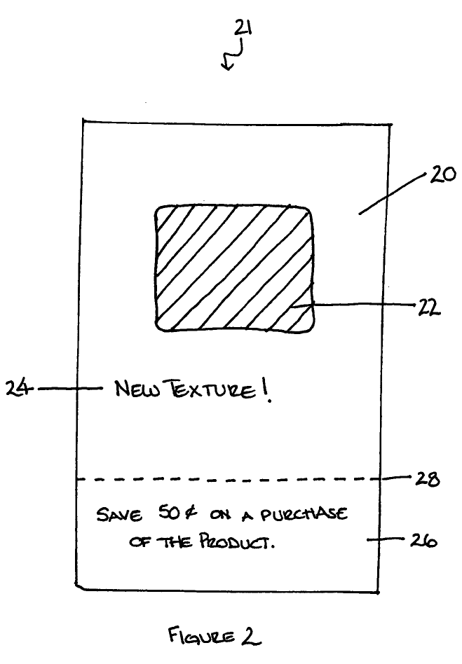

FIG. 2 illustrates a further embodiment of a marketing tool including a feature representation aspect wherein the marketing tool may be distributed to consumers. In the embodiment of FIG. 2, the marketing tool 21 comprises a base component 20 and a feature representation component 22. The base component 20 may be any desired size, structure, or device, including, for example, a promotional mailing, a flyer insert for a newspaper or magazine, a sample card for handing out, a package, a case, a box, a multipack, or a pallet. The feature representation component 22 may be integral to the base component 20, or it may be coupled to the base component 20. In an embodiment where the feature representation component 22 is integral to the base component 20, the feature representation component 22 may comprise an embossed portion of a card. The feature representation component 22 may be any size relative to the base component 20, including the same size. Thus, for example, the marketing tool may be provided as a product package, where the most or all of the outside of the product package is the feature representation component 22.

In an embodiment where the feature representation component 22 is coupled to the base component 20, the feature representation component 22 may comprise the product being advertised, or a material representing the feature of the product. Such material may comprise, for example, plastic, metal, foam, rubber, a hard material etched with a pattern, or other suitable material. The feature representation component 22 may be configured to convey any desired feature of the product, such as texture, thickness, softness, smoothness, durability, and/or scent. Thus, a material simulating the texture of product may be used as the feature representation component 22 for conveying the texture of the product. Further, a scent, for example, may be added to the material to convey the scent of the product. The marketing tool 21 may comprise advertising indicia 24 such as graphics or text identifying and advertising the product. An incentive 26 to purchase the product may further be included on the marketing tool 21. For example, the incentive 26 may comprise a coupon towards purchase of the product. The incentive 26 may be removable from the marketing tool 21 via, for example, a perforated strip 28.

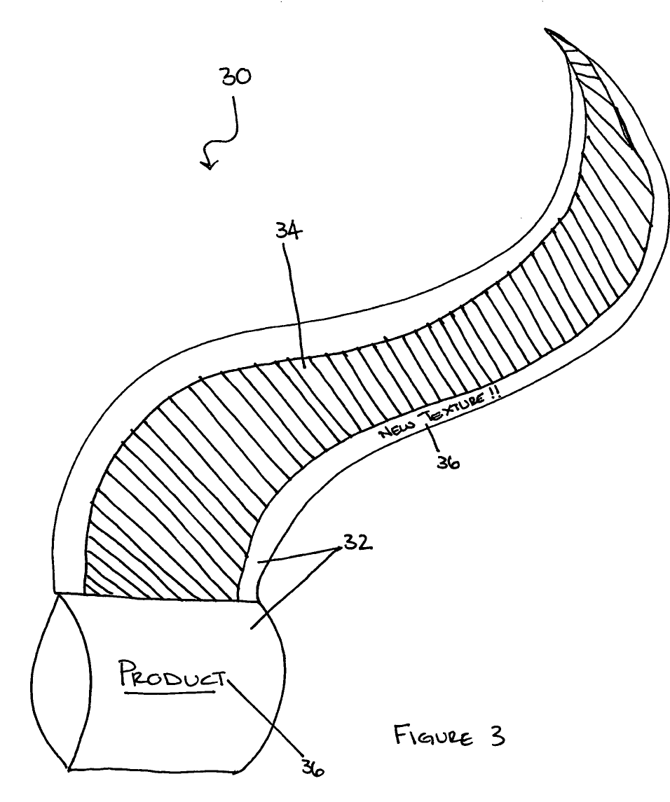

FIG. 3 illustrates yet another embodiment of a marketing tool. The marketing tool 30 comprises a front side that graphically represents the product being advertised and that may be configured to simulate a feature of the product. The embodiment shown may be used for advertising a product such as bath tissue, or paper towels. The front side of the marketing tool 30 may be configured to simulate the texture or other feature of the product and/or may comprise advertising indicia such as graphics or text identifying and advertising the product. The marketing tool 30 may comprise a material, such as a textured material, overlaying a base material. The material may be, for example, a product sample, plastic, metal, foam, rubber, a hard material etched with a pattern, or other suitable material. In such embodiment, the material may not completely cover the surface of the base material.

The back surface of the marketing tool 30 shown in FIG. 3 may comprise an affixation mechanism for attaching marketing tool 30 to, for example, a floor of an aisle where the product is sold, the inside door of a toilet stall, or to any other surface. Further, the marketing tool 30 may extend over a combination of surfaces such as starting on a wall or door and extending along the floor, or starting on one wall and extending onto one or more additional walls or other surfaces. The affixation mechanism may be adhesive, removable adhesive, static cling, magnetic material, or any suitable mechanism for attaching the marketing tool 30 to the desired target surface.

In the embodiment shown in FIG. 3, the marketing tool 30 graphically reflects a roll of bath tissue being unrolled. The marketing tool 30 may include an actual product sample, a representation of the product, or a combination of actual product(s) and representative product(s), etc. The marketing tool 30 comprises a base material 32. A portion of the front surface of the marketing tool 30 includes a material 34 simulating a feature of the product and overlaying the base material 32. As shown, the material 34 is textured and simulates the texture of the product. The material 34 may be affixed to the base material 32 in any suitable manner. The material 34 may be smaller than the base material 32, or it may be the same size as or larger than the base material 32. As shown, advertising indicia 36 may be provided on that portion of the base material 32 that is not overlayed by the material 34. In alternate embodiments, the base material and material simulating the product feature are a single material.

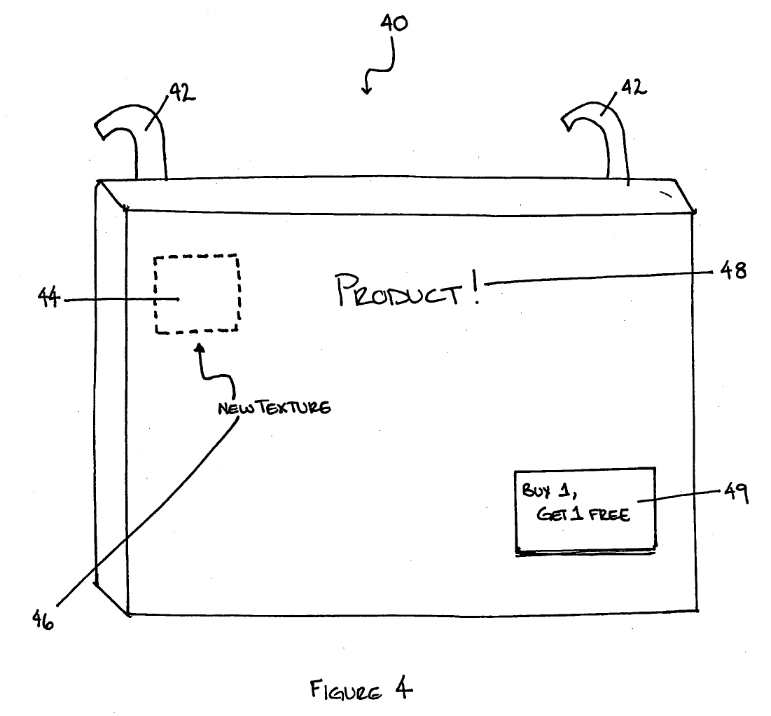

FIG. 4 illustrates a further embodiment of a marketing tool. The marketing tool 40 is configured for display on any suitable surface. For example, the marketing tool 40 may be displayed on the inside of a toilet stall. The marketing tool 40 may be coupled to the surface in any suitable manner. For example, the marketing tool 40 may be coupled to the surface via an adhesive provided on a back surface of the marketing tool, via a magnet, or via other suitable coupling mechanisms. In the embodiment shown, hooks 42 are provided for engagement with a door of a bathroom stall. The marketing tool 40 comprises a front surface advertising the product. The front surface includes a feature representation portion 44 that simulates a feature of the product. The feature representation portion 44 may comprise any material suitable for demonstrating a feature the product. For example, when simulating the texture of the product, the feature representation portion 44 may comprise plastic, metal, foam, rubber, a hard material etched with a pattern, or other suitable material. Alternately, the feature representation portion 44 may comprise a sample of the product 44. The sample of the product may be coupled to the marketing tool 40 or may be provided within the marketing tool 40. In an embodiment where a sample of the product is provided within the marketing tool, a window is provided for providing access to a feature of the product sample such that a consumer may feel the product sample through the window. Indicia 46 may be provided to prompt a consumer to use the feature representation portion 44. For example, when the feature representation portion 44 comprises a textured portion, the indicia 46 may prompt a consumer to feel the feature representation portion 44. Advertising indicia 48 such as graphics or text identifying and advertising the product may be provided. Further, incentives 49 to buy the product, such as removable coupons, may be provided on the marketing tool. Alternatively, a stack of removable product samples may be attached to the marketing tool 40. The feature representation portion 44 can be any size with respect to the marketing tool 40, from a small portion to a size that covers the entire front surface of the marketing tool 40.

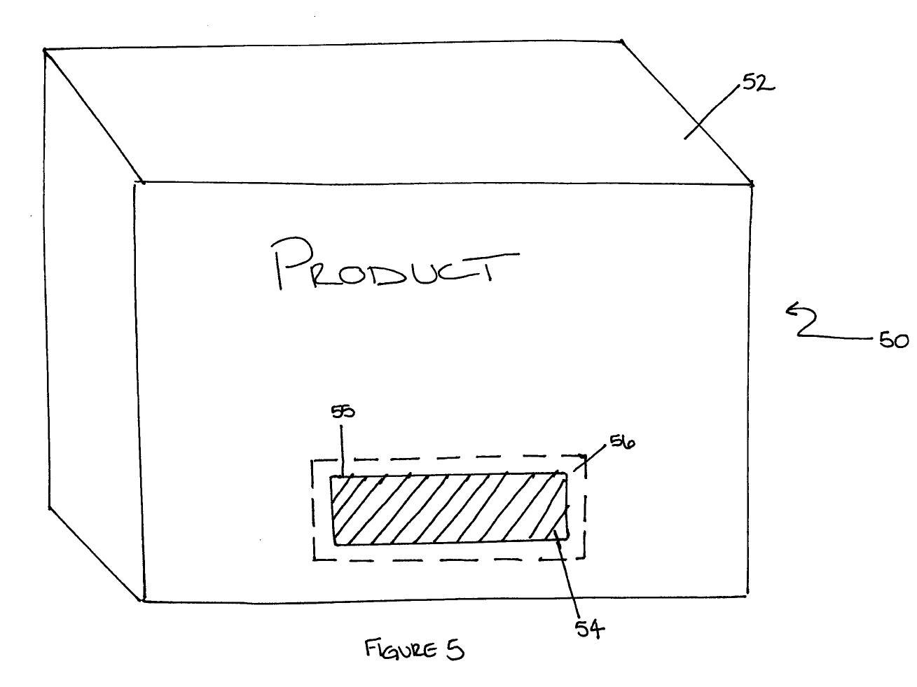

FIG. 5 illustrates an embodiment of the marketing tool 50 that is integral with product packaging 52 for the product. The product packaging 52 packages the product for distribution and/or sale. Generally, the marketing tool 50 includes a feature representation portion 54 simulating a product feature. The feature representation portion 54 may comprise the actual product or a simulation of the product. Further, the feature representation portion 54 may be provided within the product packaging 52 or on the product packaging 52. The product packaging 52 may be provided in any form. For example, the product packaging 52 may be rigid or flexible, as is known in the art.

The feature representation portion 54 demonstrates a feature of the product. The feature representation portion 54 may comprise any suitable material for communicating the feature to the consumer. For example, when the feature representation portion 54 communicates the texture of the product, the feature representation portion 54 may comprise a material simulating the texture of the product, such as plastic, metal, foam, rubber, a hard material etched with a pattern, or other suitable material. Alternately, the feature representation portion 54 may comprise a sample of the product. The feature representation portion 54 may be coupled to the product packaging 52 in any suitable manner. For example, the feature representation portion 54 may be coupled to the outside of the product packaging 52 via an adhesive. Alternately, the feature representation portion 54 may be provided within the product packaging 52.

In the embodiment shown, the feature representation portion 54 comprises a product sample provided within the product packaging 52. A window 55 is provided for allowing access to the product sample within the product packaging 52. For sanitary reasons, it may not be desirable to provide access to the interior of the product packaging 52 where product is stored. Thus, a separate compartment 56 may be provided behind the window 55 for housing the product sample. A film or other barrier may be provided over the window 55. Alternatively, a protective barrier may be provided between the product sample and the product within the interior of the product packaging.

While the invention has been described with substantial reference to physical features such as texture, softness, smoothness, thickness, and/or durability, the marketing tools may be configured for demonstrating other product features to a consumer. For example, the marketing tools may be configured for demonstrating visual or olfactory features to a consumer in lieu of or in addition to physical features. The feature or features demonstrated will depend substantially on the product being marketing and the features of the product that would be of interest to a consumer. For a dish care product such as a cleaning foam, for example, the marketing tool may be configured to communicate the appearance of the foam, the scent of the foam, and or/the texture of the foam. For a beauty care product such as a pressed powder, the marketing tool may be configured to communicate the color of the powder, the scent of the powder, and/or the texture of the powder. For a medical product such as a salve, the marketing tool may be configured to communicate the scent of the salve and the consistency of the salve. Any other features for the above products also may be communicated.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A marketing tool for informing a consumer of at least one product feature, the marketing tool comprising a feature representation aspect that demonstrates a physical feature of the product to a consumer through the use of a material that is representative of the physical feature of the product.

2. The marketing tool of claim 1, wherein the feature representation aspect comprises a textured aspect and demonstrates a texture of the product.

3. The marketing tool of claim 2, wherein the textured aspect comprises a material selected from the group consisting of plastic, metal, foam, rubber, and a hard material etched with a pattern.

4. The marketing tool of claim 1, wherein the feature representation aspect comprises a sample of the product.

5. The marketing tool of claim 1, further comprising advertising indicia.

6. The marketing tool of claim 1, further comprising an incentive to purchase the product.

7. A shopping cart comprising a marketing tool with a feature representation aspect that demonstrates a feature of a product.

8. The shopping cart of claim 7, wherein the feature representation aspect is a textured aspects and demonstrates a texture of the product.

9. The shopping cart of claim 7, wherein the textured aspect is part of a handle of the shopping cart.

10. The shopping cart of claim 9, further comprising advertising indicia.

11. The shopping cart of claim 7, wherein the feature representation aspect is part of a child seat of the shopping cart.

12. The shopping cart of claim 11, further comprising advertising indicia.

13. The shopping cart of claim 1, further comprising a second feature representation aspect for demonstrating a further product feature to the consumer.

14. A marketing tool for marketing a disposable article, the marketing tool comprising a base aspect and a texture representation aspect, wherein the texture representation aspect substantially demonstrates the texture of the disposable article to a consumer.

15. The marketing tool of claim 14, wherein the texture representation aspect comprises a material selected from the group consisting of plastic, metal, foam, rubber, and a hard material etched with a pattern.

16. The marketing tool of claim 14, further comprising a feature representation aspect for demonstrating a further product feature to the consumer.

17. The marketing tool of claim 14, wherein the marketing tool is configured for distribution to consumers.

18. The marketing tool of claim 14, wherein the texture representation aspect comprises a sample of the product being marketed.

19. The marketing tool of claim 14, further comprising an incentive to purchase the product.

20. A marketing tool for marketing a product, the marketing tool comprising:
a display having a front surface and a back surface;
an affixation mechanism provided on the back surface of the display; and
a textured material provided on the front surface of the display, wherein the textured material demonstrates a texture of the product.

21. The marketing tool of claim 20, wherein the textured material comprises a sample of the product being marketed.

22. The marketing tool of claim 21, further comprising a protective overlay over the sample of the product.

23. The marketing tool of claim 20, wherein the textured material comprises a material selected from the group consisting of plastic, metal, foam, rubber, and a hard material etched with a pattern.

24. A marketing tool comprising a display, the display being configured for coupling to a surface and having a feature representation portion demonstrating a physical feature of the product, wherein the feature representation portion is provided on a front surface of the display and wherein the marketing tool communicates the physical feature of the product to a consumer.

25. A marketing tool comprising:
a product package having an interior housing the product;
a feature representation portion simulating a feature of the product, wherein the feature representation portion is provided within the product package; and
a protective barrier between the feature representation portion and the product within the interior of the product package;
wherein the marketing tool communicates the feature of the product to a consumer.
